(19) United States
(12) Patent Application Publication
(10) Pub. No.: US 2017/0034267 A1
(43) Pub. Date: Feb. 2, 2017

(54) METHODS FOR TRANSFERRING DATA IN A STORAGE CLUSTER AND DEVICES THEREOF

(71) Applicant: NetApp, Inc., Sunnyvale, CA (US)

(72) Inventors: Balajee Nagasubramaniam, Dublin, CA (US); Vijay Singh, San Jose, CA (US)

(21) Appl. No.: 14/814,658

(22) Filed: Jul. 31, 2015

(51) Int. Cl. H04L 29/08; H04L 12/911

(52) U.S. Cl. CPC H04L 67/1097; H04L 47/781

(57) ABSTRACT

Methods, non-transitory computer readable media, and computing devices that send an allocation request for an amount of memory to a another computing device. An indication of a memory range corresponding to a plurality of remote use data buffers within a memory of the another computing device is received from the another computing device. A locally managed remote memory (LMRM) pool comprising metadata for the remote use data buffers is instantiated based on the indication of the memory range. One of the remote use data buffers in the LMRM pool is reserved. Data is sent via remote direct memory access (RDMA) to the one of the remote use data buffers. Advantageously, with this technology, a computing device can manage memory belonging to another computing device via the LMRM pool in order to transfer data more efficiently.

### FIELD

This technology relates to data storage and, more particularly, to methods and devices for transferring data in a cluster of storage node computing devices.

### BACKGROUND

Data storage networks increasingly include high performance computing (HPC) devices, such as a cluster of symmetric multiprocessor (SMP) storage node computing devices, that leverage remote direct memory access (RDMA) to move data between devices. To implement RDMA data transfers, storage node computing devices exchange a physical address range to write to, or read from, and a network adapter or interface delivers the data directly to the network, thereby facilitating reduced network latency and processor overhead for data transfer between devices. Efficient data transfer is particularly useful in clustered storage networks in which any storage node computing device can receive a request from a client device to read data from, or write data to, a storage volume hosted by any other storage node computing device in the storage cluster.

However, there is currently no way to manage memory belonging to a remote system, such as another storage node computing device in a same storage cluster. Accordingly, data cannot be written or pushed by a local storage node computing device to a remote storage node computing device via RDMA without the local storage node computing device first determining whether memory is available on the remote storage node computing device and the location of the available memory to which the data can be sent. The involvement of the remote storage node computing device prior to initiating the RDMA data transfer adds significant overhead, which is undesirable.

### SUMMARY

A method for transferring data in a storage cluster includes sending, by a computing device, an allocation request for an amount of memory to a another computing device. An indication of a memory range corresponding to a plurality of remote use data buffers within a memory of the another computing device is received by the computing device and from the another computing device. A locally managed remote memory (LMRM) pool comprising metadata for the remote use data buffers is instantiated, by the computing device, based on the indication of the memory range. One of the remote use data buffers in the LMRM pool is reserved by the computing device. Data is sent, by the computing device and via remote direct memory access (RDMA), to the one of the remote use data buffers.

A non-transitory computer readable medium having stored thereon instructions for transferring data in a storage cluster comprising executable code which when executed by a processor, causes the processor to perform steps including sending an allocation request for an amount of memory to a remote storage node computing device. An indication of a memory range corresponding to a plurality of remote use data buffers within a memory of the remote storage node computing device is received from the remote storage node computing device. An LMRM pool comprising metadata for the remote use data buffers is instantiated based on the indication of the memory range. One of the remote use data buffers in the LMRM pool is reserved. Data is sent, via RDMA, to the one of the remote use data buffers.

A computing device includes a processor and a memory coupled to the processor which is configured to be capable of executing programmed instructions comprising and stored in the memory to send an allocation request for an amount of memory to a another computing device. An indication of a memory range corresponding to a plurality of remote use data buffers within a memory of the another computing device is received from the another computing device. An LMRM pool comprising metadata for the remote use data buffers is instantiated based on the indication of the memory range. One of the remote use data buffers in the LMRM pool is reserved. Data is sent, via RDMA, to the one of the remote use data buffers.

This technology has a number of associated advantages including providing methods, non-transitory computer readable media, and devices that facilitate more efficient transfer of data between devices, such as storage node computing devices in a storage cluster. With this technology, a local storage node computing device can manage memory belonging to remote storage node computing device(s) via an LMRM pool. By using an LMRM pool, RDMA writes can proceed without a local storage node computing device determining whether memory is available in a remote storage node computing device, or the location of such memory, thereby reducing the number of communications required to implement a data transfer, as well as the associated overhead.

### BRIEF DESCRIPTION OF THE DRAWINGS

FIG. 1 a block diagram of a network environment with an exemplary storage cluster of exemplary storage node computing devices;

FIG. 2 is a block diagram of one of the exemplary storage node computing devices;

FIG. 3 is a flowchart of an exemplary method for transferring data in order to service write data requests with one of the exemplary storage node computing devices;

FIG. 4 is a flowchart of an exemplary method for servicing, by a local one of the exemplary storage node computing devices, a request to write data on a storage volume hosted by a remote one of the exemplary storage node computing devices;

FIG. 5 is a flowchart of an exemplary method for servicing, by a local one of the exemplary storage node computing devices, a request received by a remote one of the exemplary storage node computing device to write data on a storage volume hosted by the local one of the storage node computing device; and

FIG. 6 is a functional flow diagram of a method for servicing write requests with a local one of the exemplary storage node computing devices and a remote one of the storage node computing devices.

### DETAILED DESCRIPTION

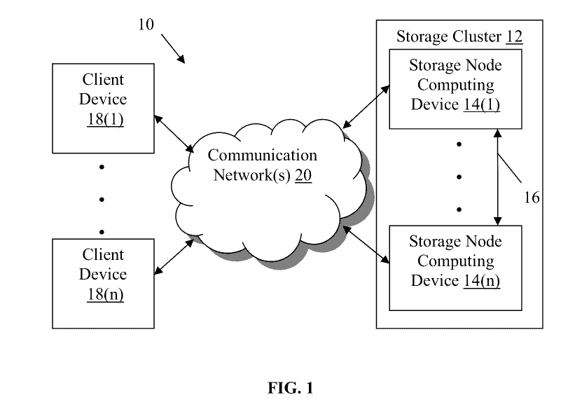

A network environment 10 including an example of a storage cluster 12 with storage node computing devices 14(1)-14(n) is illustrated in FIG. 1. The storage node computing devices 14(1)-14(n) in this particular example are coupled to each other by a cluster interconnect 16 and to client devices 18(1)-18(n) by communication network(s) 20. In other examples, this environment 10 can include other numbers and types of systems, devices, components, and/or elements in other configurations. This technology provides a number of advantages including methods, non-transitory computer readable media, and devices that facilitate more efficient remote direct memory access (RDMA) data transfer in a storage cluster using a locally managed remote memory (LMRM) pool.

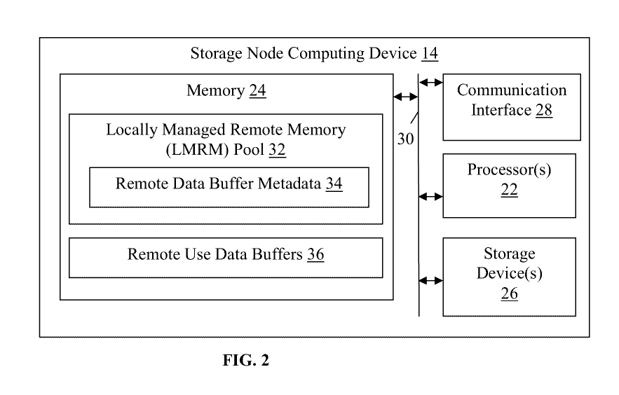

Referring to FIG. 2, a block diagram of one of the exemplary storage node computing devices 14(1)-14(n) is illustrated. The one of the storage node computing devices 14(1)-14(n) is generally configured to receive requests to write data to storage volumes hosted by the storage cluster 12 and to read data from storage volumes hosted by the storage cluster 12. The one of the storage node computing devices 14(1)-14(n) in this particular example includes processor(s) 22, a memory 24, storage device(s) 26, and a communication interface 28, and which are all coupled together by a bus 30 or other communication link, although the storage node computing device 14 can have other types and numbers of components or other elements.

The processor(s) 22 of the one of the storage node computing devices 14(1)-14(n) each executes a program of stored instructions for one or more aspects of this technology, as described and illustrated by way of the embodiments herein, although the processor(s) 22 could execute other numbers and types of programmed instructions. The processor(s) 22 in the one of the storage node computing devices 14(1)-14(n) may include one or more central processing units or general purpose processors with one or more processing cores, for example.

The memory 24 of the one of the storage node computing devices 14(1)-14(n) in this particular example may include any of various forms of read only memory (ROM), random access memory (RAM), Flash memory, non-volatile, or volatile memory, or the like, or a combination of such devices for example. In this example, the memory 24 includes the LMRM pool 32, including remote data buffer metadata 34, and remote use data buffers 36.

The LMRM pool 32 can be used by the one of the storage node computing devices 14(1)-14(n) to manage an allocated portion of the memory of another of the storage node computing devices 14(1)-14(n), as described and illustrated in more detail later. The remote data buffer metadata 34 includes information regarding the memory allocated by another of the storage computing devices 14(1)-14(n). Accordingly, the one of the storage node computing devices 14(1)-14(n) can reserve a remote use data buffer of another of the storage node computing devices 14(1)-14(n) using the remote data buffer metadata 34 prior to transferring data to the remote use data buffer, as described and illustrated in more detail later.

The remote use data buffers 36 are a portion of the memory 24 allocated by the one of the storage node computing devices 14(1)-14(n) for management by another of the storage node computing devices 14(1)-14(n). Accordingly, in this example, each of the storage node computing devices 14(1)-14(n) is configured to manage a portion of the memory of each other of the storage node computing devices 14(1)-14(n), although other configurations can also be used in other examples.

The disk storage device(s) 26 can include optical disk-based storage or any other type of storage devices suitable for storing files or objects in storage volumes for short or long term retention, for example. Other types and numbers of storage devices can be included in the memory 24 or coupled to the one of the storage node computing devices 14(1)-14(n) in other examples. Additionally, one or more disk shelves with storage devices can be included in the storage cluster 12 or elsewhere in the network 10 in one or more separate or dedicated storage servers in other examples.

The communication interface 28 of the one of the storage node computing devices 14(1)-14(n) in this example operatively couples and communicates between the one of the storage node computing devices 14(1)-14(n) and the client devices 18(1)-18(n) via the communication network(s) 20, although other types and numbers of communication networks or systems with other types and numbers of connections and configurations to other devices and elements can also be used.

By way of example only, the communication network(s) 20 can use TCP/IP over Ethernet and industry-standard protocols, including NFS, CIFS, SOAP, XML, LDAP, and SNMP, although other types and numbers of communication networks, can be used. The communication network(s) 20 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

Referring back to FIG. 1, the one of the storage node computing devices 14(1)-14(n) receives requests to write and read data from the client devices 18(1)-18(n) via the communication network(s) 20 and communicates with one or more other of the storage node computing devices 14(1)-14(n) in order to service the requests. Accordingly, each of the client devices 18(1)-18(n) includes a processor, a memory, a communication interface, and, optionally, an input device and a display device, which are coupled together by a bus or other communication link, although the client devices 18(1)-18(n) can have other types and numbers of components or other elements. One or more of the client devices 20(1)-20(n) may be, for example, a conventional personal computer, a server hosting application(s) that utilize back-end storage provided by the storage cluster 12, or any other type of processing and/or computing device.

Although examples of the storage node computing devices 14(1)-14(n) and client devices 18(1)-18(n) are described herein, it is to be understood that the devices and systems of the examples described herein are for exemplary purposes, as many variations of the specific hardware and software used to implement the examples are possible, as will be appreciated by those skilled in the relevant art(s). In addition, two or more computing systems or devices can be substituted for any one of the systems in any embodiment of the examples.

The examples also may be embodied as one or more non-transitory computer readable media having instructions stored thereon for one or more aspects of the present technology, as described and illustrated by way of the examples herein, which when executed by a processor, cause the processor to carry out the steps necessary to implement the methods of this technology, as described and illustrated with the examples herein.

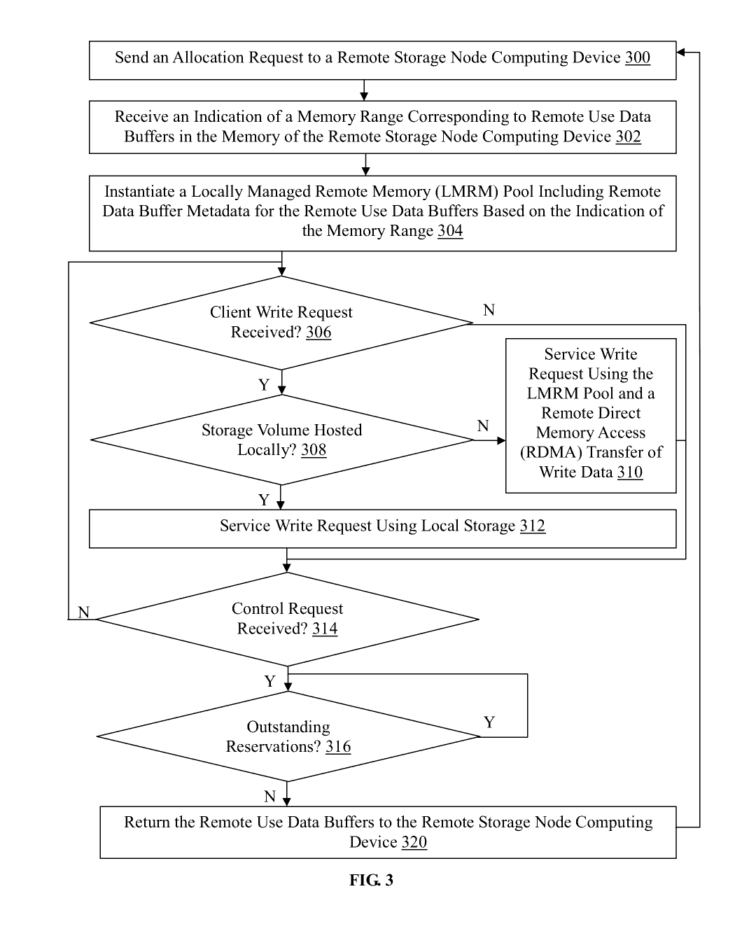

An exemplary method for transferring data in the storage cluster 12 will now be described with reference to FIGS. 1-6. The example described and illustrated herein with specific reference to FIGS. 3-6 relates to servicing a request received from one of the client devices 18(1)-18(n) to write data. While this example is illustrative of this technology, it is not intended to be limiting and there are many other contexts and use cases that can advantageously leverage this technology, and specifically can more efficiently transfer data between computing devices via RDMA using an LMRM pool.

Referring more specifically to FIG. 3, an exemplary method for transferring data in order to service a write data request with an exemplary local storage node computing devices 14(1) is illustrated. For purposes of this example only, the storage node computing device 14(1) is referred to as a local storage node computing device and a storage node computing device 14(2) is referred to as a remote storage node computing device. However, any of the storage node computing devices 14(1)-14(n) could be acting as a local or remote storage node computing device in other examples based on the direction of the data transfer.

Accordingly, in step 300 in this particular example, the local data storage computing device 14(1) sends an allocation request for an amount of memory to the remote storage node computing device 14(2). The requested amount of memory is a portion of the memory 24(2) within the remote storage node computing device 14(2) that will be managed by the local storage node computing device 14(1) via the LMRM pool 32, as described and illustrated in more detail later.

In step 302, the local storage node computing device 14(1) receives an indication of a memory range corresponding to a plurality of remote use data buffers 36(2) in the memory 24(2) of the remote storage node computing device 14(2). Accordingly, the remote use data buffers 36(2) in the memory 24(2) of the remote storage node computing device 14(2), that are identified in the indication received by the local storage node computing device 14(1) in response to the allocation request, will be managed by the local storage node computing device 14(1) and will not be used by the remote storage node computing device 14(2) to service data requests.

The remote storage node computing device 14(2) can send an indication of a single large chunk of memory 24(2) or a limited number of smaller chunks of the memory 24(2), for example. In this example, the memory range corresponds with physical memory, although in other examples virtual memory addresses could also be used. Optionally, the remote storage node computing device 14(2) can also send an RDMA network interface controller (RNIC) handle that can be used by the local storage node computing device 14(1) to facilitate RDMA data transfers, as described and illustrated in more detail later.

In step 304, the local storage node computing device 14(1) instantiates the LMRM pool 32(1) and populates the LMRMR pool 32 with remote buffer metadata including identifying information (e.g., an address range in the memory 24(2)) for the remote use data buffers 36(2). The remote data buffer metadata 34(1) can include an indication (e.g., a flag) of whether one of the remote use data buffers 36(2) is currently reserved, as described and illustrated in more detail later.

In step 306, the local storage node computing device 14(1) determines whether a request to write data is received from one of the client devices 18(1)-18(n). If the local storage node computing device 14(1) determines that a client write request is received, then the Yes branch is taken to step 308. In step 308, the local storage node computing device 14(1) determines whether the storage volume to which the write request is directed is hosted locally. Accordingly, the local storage node computing device 14(1) can analyze information contained in the write request (e.g., an identified IP address and/or storage volume indication) in order to determine whether the storage volume is hosted locally, such as in the storage device(s) 26(1).

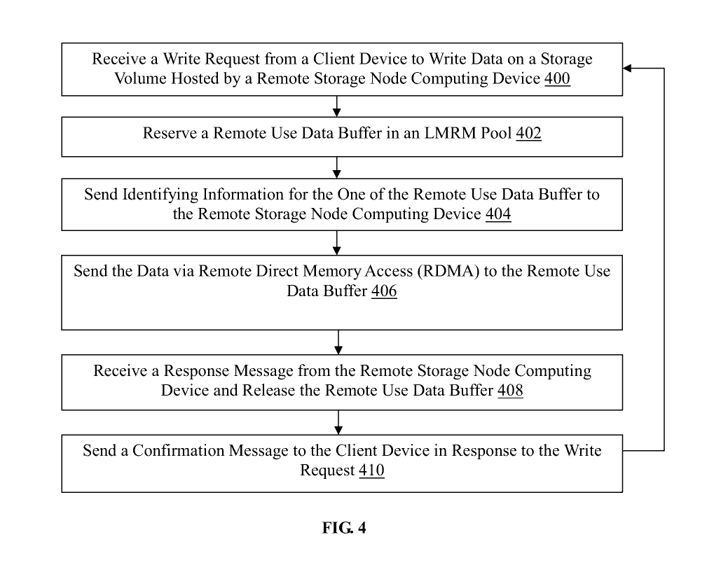

If the local storage node computing device 14(1) determines that the storage volume associated with the write request is not hosted locally, then the No branch is taken to step 310. In step 310, the local storage node computing device 14(1) services the write request using the LMRM pool 32(1) and an RDMA transfer of the write data associated with the write request, as described and illustrated in more detail later with reference to FIG. 4. Referring back to step 308, if the local storage node computing device 14(1) determines that the storage volume associated with the write request is hosted locally, then the Yes branch is taken to step 312. In step 312, the local storage node computing device services the write request using local storage, such as the storage device 26(1), for example.

Subsequent to servicing the write request using local storage in step 312, the LMRM pool 32(1) and an RDMA transfer of the write data in step 310, or if the local storage node computing device 14(1) determines in step 306 that a client write request is not received and the No branch is taken, the local storage node computing device 14(1) proceeds to step 314. In step 314, the local storage node computing device 14(1) determines whether a control request is received from the remote storage node computing device 14(2).

The control request can be a request from the remote storage node computing device 14(2) to return control of the memory range corresponding to the remote use data buffers 36(2) to the remote storage node computing device 14(2) from the local storage node computing device 14(1). In one example, the remote storage node computing device 14(2) can send the control request when it is in need of additional memory for its own use in servicing requests, although the control request can be sent for other reasons and at other times in other examples. If the local storage node computing device 14(1) determines in step 314 that a control request is not received, then the No branch is taken back to step 306.

However, if the local storage node computing device 14(1) determines in step 314 that a control request is received, then the Yes branch is taken to step 316. In step 316, the local storage node computing device 14(1) determines whether there are any outstanding reservations of the remote use data buffers 36(2), as indicated in the LMRM pool 32(1), such as in the remote buffer metadata 34, for example. Accordingly, the local storage node computing device 14(1) can analyze the remote buffer metadata 34 to determine whether any of the remote use data buffers 36(2) are currently indicated as being reserved.

The remote use data buffers 36(2) can be reserved by the local storage node computing device 14(1) as described and illustrated in more detail later with reference to step 402 of FIG. 4, and can remain outstanding until released, as described and illustrated in more detail later with reference to step 408 of FIG. 4. If the local storage node computing device 14(1) determines that there are any outstanding reservations of remote use data buffers 36(2), then the Yes branch is taken back to step 316 and the local storage node computing device 14(1) essentially waits until no reservations are outstanding for the remote use data buffers 36(1).

If the local storage node computing device 14(1) determines that there are no outstanding reservations for the remote use data buffers 36(2), then the No branch is taken to step 320. In step 320, the local storage node computing device 14(1) tears down the LMRM pool 32(1) and returns the portion of the memory 24(2) corresponding to the remote use data buffers 36(2) to the remote storage node computing device 14(2). Subsequent to returning the remote use data buffers 36(2) to the remote storage node computing device 14(2), the local storage node computing device 14(1) will service write requests in step 310 without using an LMRM pool, as is known in the art and will not therefore be described in detail herein.

Referring more specifically to FIG. 4, a flowchart of an exemplary method for servicing, by the local storage node computing device 14(1), a request to write data on a storage volume hosted by the remote storage node computing device 14(1), such as in step 310 of FIG. 3, is illustrated. In step 400 in this example, the local storage node computing device 14(1) receives a request from one of the client devices 18(1)-18(n) to write data on a storage volume hosted by the remote storage node computing device 14(2).

In step 402, the local storage node computing device 14(1) reserves, in the LMRM pool 32(1), one of the remote use buffers 36(2) in the memory 24(2) of the remote storage node computing device 14(2) that does not currently have an outstanding reservation. In order to reserve the one of the remote use data buffers 36(2), the local storage node computing device 14(1) modifies a portion of the remote buffer metadata 34(1) to indicate that the one of the remote use data buffers 36(2) is currently reserved (e.g., by setting an associated flag, although any other method of indicated a reservation can also be used). Since the remote storage node computing device 14(2) has currently delegated the management of the range in the memory 24(2) corresponding to the reserved one of the remote use data buffers 36(2), the local storage node computing device 14(1) can be sure that the range in the memory 24(2) of the remote storage node computing device 14(2) is not currently in use.

In step 404, the local storage node computing device 14(1) sends identifying information for the one of the remote use data buffers 36(2) to the remote storage node computing device 14(2) in order to communicate to the remote storage node computing device 14(2) the location in which the write data will be available. The identifying information can be a memory address or range in the memory 24(2) or an indication of the one of the remote use data buffers 36(2), for example.

The identifying information can be sent by the local storage node computing device 14(1) and to the remote storage node computing device 14(2) via a transmission control protocol (TCP) connection on the cluster interconnect 30, for example, although other methods of communicating the identifying information can also be used. In some examples, the write metadata (e.g., protocol header information), separated from the write data and included in the request received from the one of the client devices 18(1)-18(n), is also sent by the local storage node computing device 14(1) with the identifying information.

In step 406, the local storage node computing device 14(1) sends the write data from the request received from the one of the client devices 18(1)-18(n) via RDMA to the one of the remote use data buffers 36(2) over an RDMA path established with the remote storage node computing device 14(2), although other methods of sending the write data can be used in other examples. While step 406 is illustrated in FIG. 4 as occurring subsequent to step 404, the write data can be sent prior or in parallel to the identifying information and optional write metadata in other examples. Accordingly, the write data is advantageously sent to the remote storage node computing device 14(1) without requiring that the local storage node computing device 14(1) first communicate with the remote storage node computing device 14(2) to determine whether memory 24(2) was available or to obtain a location in the memory 24(2) to which the write data was to be transferred via RDMA.

In step 408, the local storage node computing device 14(1) receives a response message from the remote storage node computing device 14(2) and releases the one of the remote use data buffers 36(2). The response message in this example indicates that the write data was received at, and/or retrieved from, the one of the remote use buffers 36(2). Since the local storage node computing device 14(1) has received confirmation that the transfer of the write data has been completed, the local storage node computing device 14(1) can release the one of the remote use data buffers 36(2), such as by resetting a flag or otherwise removing the indication of the reservation of the one of the remote use data buffers 36(2) in the remote buffer metadata of the LMRM pool 32(1), for example, although other methods of releasing the one of the remote use data buffers 36(2) can also be used.

In step 410, the local storage node computing device 14(1) sends a confirmation message to the one of the client devices 18(1)-18(n) in response to the write request received in step 400. The confirmation message can include an indication that the requested write has been successfully completed, for example. Subsequent to sending the confirmation message, or during any of steps 402-410, the local storage node computing device 14(1) proceeds to receive another write request from the one of the client devices 18(1)-18(n) or another of the client devices 18(1)-18(n) in step 400.

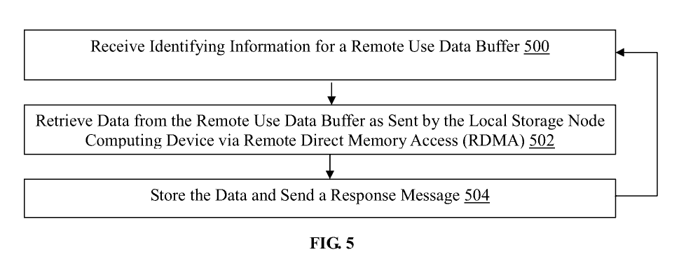

Referring more specifically to FIG. 5, a flowchart of an exemplary method for servicing, by the local storage node computing device 14(1), a request received by the remote storage node computing device 14(2) to write data on a storage volume hosted by the local storage node computing device 14(1) is illustrated. While steps 500-504 of FIG. 5 are described and illustrated herein from the perspective of the local storage node computing device 14(1), the same steps 500-504 of FIG. 5 would be performed by the remote storage node computing device 14(2) in order to service the write request received by the local storage node computing device 14(1) in step 400 of FIG. 4.

Accordingly, in step 500 in this example, the local storage node computing device 14(1) receives identifying information for one of the remote use data buffers 36(1) and, optionally, associated metadata (e.g., protocol header information). The identifying information can be received via a TCP connection with the remote storage node computing device 14(1) over the cluster interconnect 16, and can be sent by the remote storage node computing device 14(2) as described and illustrated in more detail earlier with reference to step 404 of FIG. 4. Additionally, the identifying information can be a range within the memory 24(1) of the local storage node computing device 14(1) or a unique identifier for the one of the remote use data buffers 36(1), for example, although other types of identifying information can also be used.

In step 502, the local storage node computing device 14(1) retrieves data from the one of the remote use data buffers 36(1) corresponding to the identifying information received in step 500. The data can be write data associated with a write request received from one of the client devices 18(1)-18(n) by the remote storage node computing device 14(2) or any other type of data. The data could have been sent to the one of the remote use data buffers 36(1) by the remote storage node computing device 14(2) via RDMA, such as described and illustrated earlier with reference to step 406 of FIG. 4, for example, although other methods for sending the data could also be used.

In step 504, the local storage node computing device 14(1) stores the data and sends a response message to the remote storage node computing device 14(2). The local storage node computing device 14(1) can use the metadata received in step 500 to store the data at a location on the storage device(s) 26(1), for example, although the data can be stored elsewhere in other examples. The response message can indicate that the write was performed successfully, and can be received by the remote storage node computing device 14(2) as described and illustrated in more detail earlier with reference to step 408 of FIG. 4.

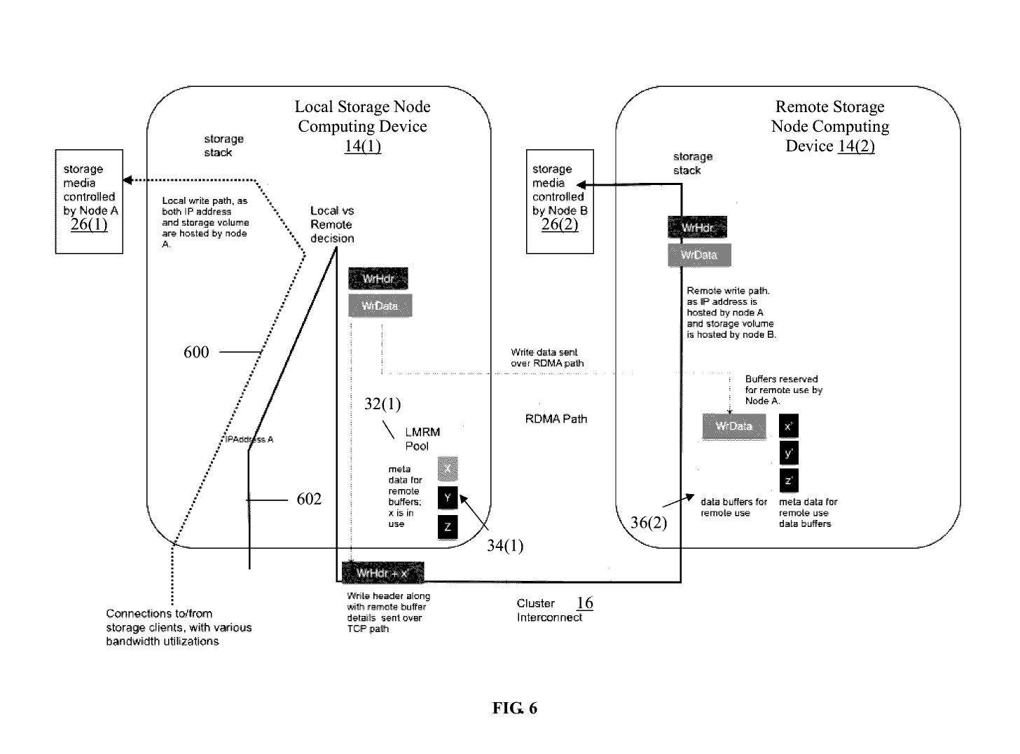

Referring more specifically to FIG. 6, a functional flow diagram of a method for servicing write requests with the local storage node computing device 14(1) and the remote storage node computing device 14(2) is illustrated. In this example, in the local write path 600, the local storage node computing device 14(1) receives a request to write data from a storage client, such as one of the client devices 18(1)-18(n), for example. The local storage node computing device 14(1) determines that the storage volume corresponding to the write request is hosted locally and the storage stack proceeds to service the write request using the storage media or device(s) 26(1).

In the remote write path 602, the local storage node computing device 14(1) again receives a request to write data from a storage client, such as one of the client devices 18(1)-18(n), for example. However, the local storage node computing device 14(1) in this example determines that the storage volume corresponding to the write request is hosted remotely by the remote storage node computing device 14(2). Accordingly, the local storage node computing device 14(1) splits the write header metadata and the write data from the write request and reserves in the LMRM pool 32(1) one of the remote use data buffers 36(2) (identified as “x” in this example) using the metadata 34(1).

The local storage node computing device 14(1) then sends, over a TCP path via the cluster interconnect 16, the write header metadata and identifying information for the one of the remote use data buffers 36(2) to the remote storage node computing device 14(2). In parallel, or prior or subsequent to sending the write header metadata and the identifying information, the local storage node computing device 14(1) sends the write data over an RDMA path to the one of the remote use data buffers 36(2) on the remote storage node computing device 14(2).

Upon receipt of the identifying information, the remote storage node computing device 14(2) is made aware that the write data is available in the one of the remote use data buffers 36(2) and retrieves the write data from the one of the remote use data buffers 36(2). The remote storage node computing device 14(2) then recombined the write header metadata and the write data and the storage stack of the remote storage node computing device 14(2) services the write request using the storage media or device(s) 26(2).

Accordingly, with this technology, data can be transferred between devices, such as storage node computing devices in a storage cluster, more efficiently. More specifically, local storage node computing devices can manage a portion of the memory on eon or more remote storage node computing devices via an LMRM pool, such that RDMA data transfers can proceed without a local storage node computing device first determining whether memory is available on a remote storage node computing device and a location within the memory to which the data should be sent via RDMA. By reducing the number of communications between devices during a data transfer, the amount of time required for the transfer and resources (e.g., network overhead) used in the transfer can advantageously be reduced.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for transferring data in a storage cluster, the method comprising:
sending, by a computing device, an allocation request for an amount of requested memory to another computing device;
receiving, by the computing device and from the another computing device, an indication of a memory range corresponding to a plurality of remote use data buffers within a device memory of the another computing device;
instantiating, by the computing device, a locally managed remote memory (LMRM) pool comprising metadata for the remote use data buffers based on the indication of the memory range;
reserving, by the computing device, one of the remote use data buffers in the LMRM pool; and
sending, by the computing device and via remote direct memory access (RDMA), data to the reserved one of the remote use data buffers.

2. The method of claim 1, further comprising receiving, by the computing device, a write request from a client device to write the data to a storage volume hosted by the another computing device and reserving the reserved one of the remote use data buffer and sending via RDMA the data in response to the write request.

3. The method of claim 2, further comprising:
sending, by the computing device, identifying information for the reserved one of the remote use data buffers to the another computing device;
releasing, by the computing device, the reserved one of the remote use data buffers in the LMRM pool upon receiving a response message from the another computing device indicating successful receipt of the data; and
sending, by the computing device, a write response to the client device in response to the write request.

4. The method of claim 1, further comprising:
receiving, by the computing device, identifying information for another remote use data buffer stored locally;
retrieving, by the computing device, additional data from the another remote use data buffer; and
sending, by the computing device, a response message to the another computing device indicating successful receipt of the additional data.

5. The method of claim 1, further comprising:
determining, by the computing device, when a control request is received from the another computing device;
determining, by the computing device, when one or more reservations of one or more of the remote use data buffers are outstanding, when the determining indicates a control request is received; and
returning, by the computing device, the memory range to the another computing device, when the determining indicates that one or more reservations are not outstanding.

6. A non-transitory computer readable medium having stored thereon instructions for transferring data in a storage cluster comprising executable code which when executed by a processor, causes the processor to perform steps comprising:
sending an allocation request for an amount of requested memory to a computing device;
receiving, from the computing device, an indication of a memory range corresponding to a plurality of remote use data buffers within a device memory of the computing device;
instantiating a locally managed remote memory (LMRM) pool comprising metadata for the remote use data buffers based on the indication of the memory range;
reserving one of the remote use data buffers in the LMRM pool; and
sending, via remote direct memory access (RDMA), data to the reserved one of the remote use data buffers.

7. The non-transitory computer readable medium of claim 6, further having stored thereon at least one additional instruction comprising executable code which when executed by the processor, causes the processor to perform at least one additional step comprising receiving a write request from a client device to write the data to a storage volume hosted by the computing device and reserving the reserved one of the remote use data buffer and sending via RDMA the data in response to the write request.

8. The non-transitory computer readable medium of claim 7, further having stored thereon at least one additional instruction comprising executable code which when executed by the processor, causes the processor to perform at least one additional step comprising:
sending identifying information for the reserved one of the remote use data buffers to the computing device;
releasing the reserved one of the remote use data buffers in the LMRM pool upon receiving a response message from the computing device indicating successful receipt of the data; and
sending a write response to the client device in response to the write request.

9. The non-transitory computer readable medium of claim 6, further having stored thereon at least one additional instruction comprising executable code which when executed by the processor, causes the processor to perform at least one additional step comprising:
receiving identifying information for another remote use data buffer stored locally;
retrieving additional data from the another remote use data buffer; and
sending a response message to the computing device indicating successful receipt of the additional data.

10. The non-transitory computer readable medium of claim 6, further having stored thereon at least one additional instruction comprising executable code which when executed by the processor, causes the processor to perform at least one additional step comprising:
determining when a control request is received from the computing device; and
determining when one or more reservations of one or more of the remote use data buffers are outstanding, when the determining indicates a control request is received; and
returning the memory range to the computing device, when the determining indicates that one or more reservations are not outstanding.

11. A computing device, comprising at least one processor and a memory coupled to the processor which is configured to be capable of executing programmed instructions comprising and stored in the memory to:
send an allocation request for an amount of requested memory to another computing device;
receive, from the another computing device, an indication of a memory range corresponding to a plurality of remote use data buffers within a device memory of the another computing device;
instantiate a locally managed remote memory (LMRM) pool comprising metadata for the remote use data buffers based on the indication of the memory range;
reserve one of the remote use data buffers in the LMRM pool; and
send, via remote direct memory access (RDMA), data to the reserved one of the remote use data buffers.

12. The computing device of claim 11, wherein the processor coupled to the memory is further configured to be capable of executing at least one additional programmed instruction to receive a write request from a client device to write the data to a storage volume hosted by the another computing device and reserving the reserved one of the remote use data buffer and sending via RDMA the data in response to the write request.

13. The computing device of claim 12, wherein the processor coupled to the memory is further configured to be capable of executing at least one additional programmed instruction to:
send identifying information for the reserved one of the remote use data buffers to the another computing device;
release the reserved one of the remote use data buffers in the LMRM pool upon receiving a response message from the another computing device indicating successful receipt of the data; and
send a write response to the client device in response to the write request.

14. The computing device of claim 11, wherein the processor coupled to the memory is further configured to be capable of executing at least one additional programmed instruction to:
receive identifying information for another remote use data buffer stored locally;
retrieve additional data from the another remote use data buffer; and
send a response message to the another computing device indicating successful receipt of the additional data.

15. The computing device of claim 11, wherein the processor coupled to the memory is further configured to be capable of executing at least one additional programmed instruction to:
determine when a control request is received from the another computing device; and
determine when one or more reservations of one or more of the remote use data buffers are outstanding, when the determining indicates a control request is received; and
return the memory range to the another computing device, when the determining indicates that one or more reservations are not outstanding.
